(19) United States
(12) Patent Application Publication
(10) Pub. No.: US 2023/0270077 A1
(43) Pub. Date: Aug. 31, 2023

(54) METHOD AND SYSTEM FOR DETERMINING PHASE TRANSITION IN YOUNG ANIMAL

(71) Applicant: Nedap N.V., Groenlo (NL)

(72) Inventors: Rudie Jan Hendrik LAMMERS, Eibergen (NL); Jort Johannes Wilhelmus SCHUTTE, Heeten (NL); Roxie Sabri Romero MULLER, Enschede (NL); Arnoldus Gerardus Franciscus HARBERS, Groenlo (NL)

(21) Appl. No.: 18/014,124

(22) PCT Filed: Jul. 2, 2021
(86) PCT No.: PCT/NL2021/050417

§ 371 Date: Dec. 30, 2022

(30) Foreign Application Priority Data
Jul. 3, 2020 (NL) 2025991

(51) Int. Cl. A01K 29/00; G05B 13/02

(52) U.S. Cl. CPC A01K 29/005; G05B 13/0265; A01K 11/007

(57) ABSTRACT

This document relates to a method for determining in a young animal a phase transition from a first development phase to a second development phase. The method comprises measuring, with a measuring instrument, one or more body or behavior parameters of the animal during a period of time and producing one or more measuring values for the or each measured body or behavior parameter. The one or more measuring values are received by a controller with which the phase transition is detected on the basis of the measuring values. The step of detecting the phase transition comprises processing the measuring values and, depending thereon, determining an extent of the animal's attention to solid food. Further, the document relates to the training of a self-learning data processing model, and to a livestock management system.

### FIELD OF THE INVENTION

The present invention relates to a method for determining in a young animal a phase transition from a first development phase to a second development phase. The invention also relates to a method for training a self-learning data processing model for use in a method as described above. Further, the invention relates to a livestock management system.

### BACKGROUND

In managing livestock in livestock farming, establishing phase transitions in the development is important, for instance to be able to tune the care needs to them. For instance, young animals are typically divided into groups, where the animals within each group have more or less similar care needs, as in respect of feeding or particular health checks. Determining whether a young animal is due to be put in a different group is conventionally done on the basis of age.

Also in quite young animals, the needs are tuned to the development phase, this development phase being estimated on the basis of age. This is for instance done in the weaning of animals. Weaning means: the transition of a wholly or partly milk-fed animal to an animal that gets no milk anymore, but different foodstuffs. In the current situation, the moment of transition from milk feed to completely different feed is mainly determined by the age of the animal and a more or less subjective observation of the farmer who determines whether the animal is ready for weaning.

This method has inherent drawbacks. Weaning an animal too soon or too late may lead to damage. Weaning is a risk moment for the animal's health and resistance. Weaning too soon leads to damage in that the animal is not yet sufficiently able to absorb solid food to compensate for the milk nourishment coming to an end. Weaning too late, however, is not desirable either, the milk nourishment is more expensive than solid food.

Also in the above-mentioned example of transfer to another group, the conventional method leads to unwanted effects. Housing too young animals among older animals leads to competition and stress, and may cause diseases or reduced growth. As yet, however, there are no methods or systems available with which such phase transitions, which are indicative of a transition moment such as weaning or a transfer to another group, can be objectively established.

### SUMMARY OF THE INVENTION

It is an object of the present invention to remove the above-mentioned disadvantages of the prior art in any case in part and to provide a method which enables objective detection of phase transitions in the development of a young animal.

To this end, the invention according to a first aspect thereof provides a method for determining in a young animal a phase transition from a first development phase to a second development phase, the method comprising: with a measuring instrument, measuring during a period of time one or more body or behavior parameters of the animal and producing one or more measuring values for the or each measured body or behavior parameter; with a controller, receiving the one or more measuring values and detecting the phase transition on the basis of the measuring values; wherein the step of detecting the phase transition comprises a step of, with the controller, processing the or each measuring value and, depending thereon, determining an extent of the animal's attention to solid food, for on the basis thereof detecting the phase transition.

The method according to the present invention makes use of a measuring instrument for measuring body or behavior parameters. This may be a measuring instrument such as a camera, with which the behaviors of an animal can be established, or a measuring instrument which is attached to the animal (for example, an ear tag, leg tag, neck tag, tail tag) or introduced into the animal (for example, a stomach bolus or other introduced sensor). The measuring instrument produces measuring values which are processed by the controller, and which make it possible to objectively establish the extent of the animal's attention to solid food. Thus, on the basis of camera pictures or a proximity sensor, it can be established how often and for how long an animal is in the vicinity of a feeding trough, or how often and for how long an animal suckles its mother. On the basis of these measurements, the extent of attention can be established qualitatively (for instance in categories: ‘much’, ‘average’, ‘little’, or ‘never’) or quantitatively (in a numerical value or an analog measuring signal). This can be used as an objective observation to establish a phase transition. In this way, the method according to the invention enables a livestock farmer to optimally establish a transition moment or transition period (start of weaning, transfer into a different group).

The method according to the invention can be used for identifying phase transitions in animals, and in that regard is not limited to a specific kind of animals. Within livestock farming, the method can be used advantageously, for instance to keep track of the development of piglets, calves, foals, lambs or other young animals. However, the method can also be used in breeding programs, not necessarily within livestock farming. In the following, frequently reference will be made to application examples in calves, but the invention is not limited thereto.

In some embodiments, the step of detecting the phase transition comprises a step of, with the controller, comparing at least one or each measuring value with a limiting value, and establishing the phase transition when the at least one measuring value has exceeded or fallen below the limiting value. The one or more body or behavior parameters may for instance be chosen from a group comprising: eating time, amount of consumed solid food, amount of milk drunk, rumination amount, number of rumination boluses and number of rumination strokes, time spent on drinking milk, ratio between eating time and time spent on drinking milk, ratio between eating time and rumination time, amount of absorbed feed with respect to absorbed amount of solid food, weight, development, height, width, activity, shape, rumen filling, hygiene score, locomotion score, water drinking, time spent in different fields of interest such as feeding fence, concentrate box, water trough, hay rack, and milk issue point. Such parameters can represent absolute or relative values, in the latter case for instance a relative eating time (with respect to all time spent on food), a relative amount of consumed solid feed, or a relative rumination amount with respect to a total amount of feed. A phase transition may for instance be detected by comparing one or more of the above parameters with a limiting value. For instance, if the time spent on drinking milk falls below a limiting value, this can be seen as an indication of a phase transition. In addition, it may be determined whether a particular combination of such conditions is met, such as: the time spent on drinking milk below a limiting value and the relative amount of consumed solid feed above a limiting value, or other combination of conditions.

Time spent in various fields of interest such as spots where solid food (roughage, concentrated feed) is obtainable, or places where water is obtainable, etc., can be measured with a position determination system. Thus, the time can be determined that is spent in these fields or, conversely, the time that is not spent in these fields. Also, specifically an area where milk can be furnished may be qualified as a field of interest, such as an automatic drink dispenser, bottle, the mother's udder, etc. Time that is spent here is also indicative of transition to the weaning phase.

According to some embodiments, the controller is configured for implementing a data processing model, wherein the step of detecting the phase transition comprises a step of, with the controller, inputting at least one of the measuring values into the data processing model and determining with the data processing model whether an amount of solid food that has been consumed by the animal has exceeded a threshold value. On the basis of parameters such as eating time, rumination amount, number of rumination boluses and number of rumination strokes, an indication can be obtained of an amount of solid feed consumed by the animal. This amount may in itself be compared with a limiting value to objectively establish whether there is a phase transition in the animal. Thus, according to some embodiments, the phase transition may for instance be established when the amount of solid food that has been consumed by the animal is at least 0.1 kilogram a day. For different animal species, different limiting values may be applied. For instance, for calves the limiting value for the amount of solid food that has been consumed by the animal can be at least 500 grams (0.5 kilogram) a day, whereas for piglets a limiting value may be used of, for example, 50 grams a day. For other animals, the phase transition may be established when the amount of solid food that has been consumed by the animal is at least 0.5% of a body weight of the animal, a day. The limiting values may for instance be settable for a user, and the above-mentioned values are only indicative.

In an embodiment, the data processing model is for instance a self-learning data processing model, where the self-learning data processing model has been trained in a training method through input of a training set consisting of training measuring values of at least one of the one or more body or behavior parameters and result values associated with the training measuring values, the result values comprising at least one of: a Boolean value indicating whether the amount of solid food that has been consumed by the animal has exceeded a threshold value; an expectation value of the amount of solid food that has been consumed by the animal. By training a self-learning data processing model in this way, such model, once trained, can be used for, on the basis of these measurements, establishing for instance an eaten amount of solid feed or when this has exceeded the limiting value for establishing the phase transition. In an embodiment, the self-learning data processing model is at least one from a group comprising: a neural network, a random forest algorithm, and an arithmetic regression model such as a simple or multiple linear regression model or a simple or multiple nonlinear regression model.

A self-learning data processing model as described above may be trained on the basis of different measurable parameters. For this, for instance, the one or more body or behavior parameters can comprise at least one from a group comprising: eating time, rumination amount, number of rumination boluses and number of rumination strokes, heart rate, heart rate variation, oxygen saturation level, and breathing frequency, weight, shape (condition), time spent in fields of interest. Such parameters, which are related to the activity of the animal (for instance, whether it is eating) or to the metabolism, may in combination be indicative of, for instance, an eaten amount of solid feed or when such amount has exceeded the limiting value.

According to some embodiments, the animal is a calf and the first development phase is a suckling phase and the second development phase is a weaning phase. Being able to objectively determine an optimum moment or optimum period of time when the calf should be weaned is valuable to prevent insufficient food absorption or undernourishment as a result of premature weaning, and also to be able to prevent milk feeding being continued too long.

In some of these embodiments, the method further comprises the step of, depending on the determined extent of the animal's attention to solid food, providing an indication signal for running down the suckling phase. The indication signal has as an advantage for the farmer, especially in keeping a large group of animals, that the signal facilitates the processes in the operation. For instance, the signal may be used for the purpose of, for example, automatic or semiautomatic separation of animals, or it may be incorporated in a daily overview in which it is indicated to the farmer which calves are ready to be weaned.

In some embodiments, the method comprises the step of, depending on the determined extent of the animal's attention to solid food, determining an advised value of an amount of milk per period of time that can be offered to the animal. In this way, on the basis of the determined extent of attention to solid food, the milk consumption of the animal can be gradually run down, so that it is tuned to the animal's individual need.

According to other embodiments, the phase transition is accompanied by a displacement of the animal from a group of animals in a first age category to a group of animals in a second age category, and wherein the method further comprises the steps of, after displacement of the animal, monitoring at least one of the one or more body or behavior parameters, and determining therefrom a state of health of the animal, such as, for example, a stress condition of the animal. Because such a transfer may cause stress in the animal, for instance when transfer has taken place too early after all, monitoring the behavior of the animal after transfer has added value.

According to other embodiments, the method further comprises producing an attention signal when the amount of solid food that has been consumed by the animal has exceeded a threshold value. The amount of solid food that an animal eats is a direct measure of the extent of attention to it and, when determined, forms a good indication for execution of the method.

According to some embodiments, the measuring instrument is at least one from a group comprising: an ear tag, a neck tag, a leg tag, a stomach bolus, a tail sensor, a camera, or a microphone. Such measuring instruments may be provided with units for measuring a variety of behavior and body parameters on the basis of which the method according to the invention can be implemented. Thus, the tags concerned that are worn by the animal (on or in the animal) may be provided with an accelerometer or other movement sensors which can provide insight into specific movements associated with particular behaviors. It may for instance be established whether an animal is eating or is stressed, or is ruminating. According to some embodiments, the sensors comprise at least one sensor from a group comprising: a movement sensor, a heart rate sensor, a breathing sensor, an optical sensor for measuring one or more blood levels, a positioning system for determining a current position, a pressure sensor, or a chromatograph.

According to some embodiments, the one or more body or behavior parameters comprise at least the number of rumination boluses, and the measuring instrument is designed with a movement sensor, in which the number of rumination boluses is measured by at least one of the following steps: with the movement sensor, measuring animal movements, analyzing the measured animal movements for distinguishing movements that are indicative of rumination strokes, recognizing a rumination stroke pattern consisting of one or more series of rumination strokes which are each followed by a pause in which no rumination strokes are observed, and counting at least one of the number of series of rumination strokes or the number of pauses for establishing the number of rumination boluses, wherein each series or each pause represents one rumination bolus; or, with the movement sensor, measuring animal movements, analyzing the measured animal movements for distinguishing movements that are indicative of at least one of regurgitations or swallowing movements, and counting the number of regurgitations or swallowing movements for establishing the number of rumination boluses. Rumination boluses give a specific movement signal that can be properly established with movement sensors (for example on the neck or the ear of the animal, or with a stomach bolus).

According to some embodiments, the measuring instrument is physically and communicatively connected with the controller. The controller may for instance be in the neck tag or the stomach bolus (or other instrument) and for instance process the measurements there directly. For instance, in some embodiments, the measuring instrument and the controller are part of a same device which is attached to or introduced into the animal. When the measuring instrument is a camera, the controller may also be present in or at it. According to some embodiments, the controller is contained in a livestock management server, with the measuring instrument sending the measuring values via a wireless connection to the controller. In this last variant, the measuring values are centrally processed. Also, a mixed form may be used, where measuring values, for instance, are first worked up in the measuring instrument, and then further analyzed centrally in the server. It is also possible that the server is only communicatively in communication (via a wired or wireless connection, for instance via a data communication network) with a controller or with another entity in which the controller is present. Further, the server may or may not be locally present, for example a local livestock management server of a farm, or work may be done with a remote server which receives the measuring values by means of a data communication network, such as a server in the cloud.

As mentioned earlier, the measuring instrument may be attached to or introduced into the animal, and may be provided with one or more sensors. Alternatively or additionally, the measuring instrument may be a camera which is operatively connected with an image recognition system for establishing the body or behavior parameters. A further alternative is the use of a microphone as measuring instrument. A microphone may then be placed in a barn or monitored field, optionally in combination with a camera. Also, merely a camera may be in place. It is also possible that a microphone as a sensor is part of a tag. Similarly to the camera, also the microphone may be used for measuring body or behavior parameters, for instance by recognizing sounds indicating a particular state of mind or activity of an animal.

According to a second aspect, the present invention relates to a method for training a self-learning data processing model for use in a method according to the first aspect. The training method comprises the steps of: inputting into the data processing model a training set consisting of training measuring values, wherein the training measuring values comprise one or more body or behavior parameters and result values, wherein the result values are associated with the training measuring values, and wherein the result values comprise at least one of: a Boolean value indicating whether the amount of solid food that has been consumed by the animal has exceeded a threshold value; an expectation value of an amount of solid food that has been consumed by the animal. Such a trained self-learning data processing model can be used with advantage in a method according to the first aspect.

According to a third aspect, the present invention relates to a livestock management system configured for executing a method according to the first aspect for, in each individual animal of a group of young animals, determining a phase transition from a first development phase to a second development phase, the system comprising a plurality of measuring instruments attachable to or introducible into an animal of the group of animals and wherein the measuring instruments are each provided with one or more sensors for measuring during a period of time one or more body or behavior parameters of the respective animal, and producing one or more measuring values for the or each measured body or behavior parameter; and a controller configured for receiving the one or more measuring values of each measuring instrument and detecting the phase transition on the basis of the measuring values; wherein the step of detecting the phase transition comprises a step of, with the controller, processing the or each measuring value and, depending thereon, determining whether an amount of solid food that has been eaten by the animal has exceeded a threshold value.

### BRIEF DESCRIPTION OF THE FIGURES

The invention will be discussed below on the basis of specific embodiments thereof, not intended as limiting, with reference to the appended figures, in which:

FIG. 1 is a schematic representation of a system according to an embodiment for use in a method according to the invention;

FIG. 2 schematically shows a training method according to an embodiment for training a self-learning data processing model for use in a method according to the invention;

FIG. 3 shows a livestock management system according to an embodiment for use in a method according to the invention;

FIG. 4 shows a livestock management system according to an embodiment including a separation gate for use in a method according to the invention;

FIG. 5 schematically shows a method according to an embodiment of the present invention.

### DETAILED DESCRIPTION

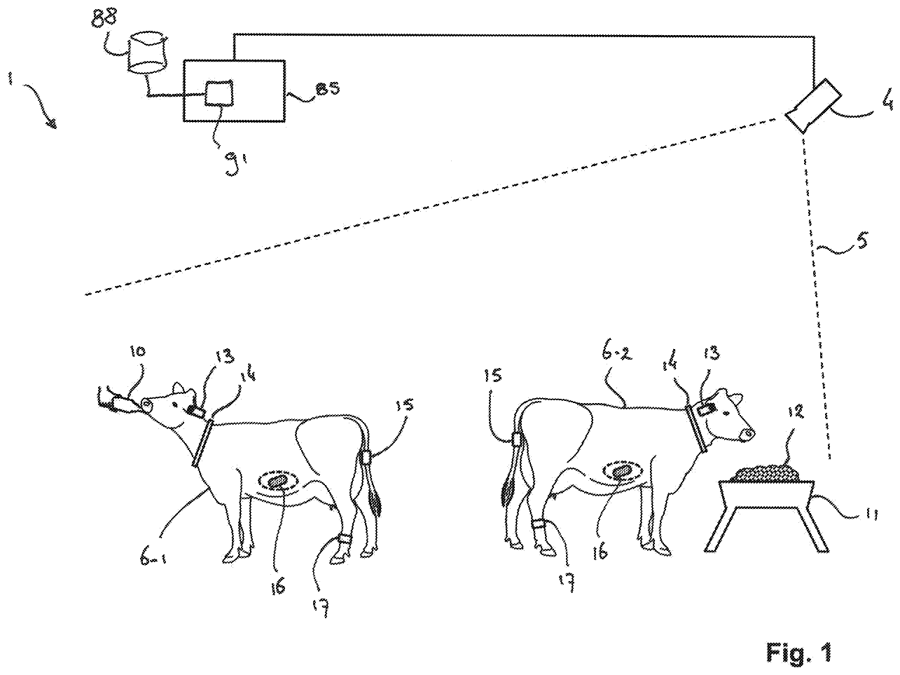

FIG. 1 is a schematic representation of a system 1 for establishing a phase transition in an animal 6. The system 1 comprises a server 85 which is communicatively connected with measuring instruments 4 and 13-17. In the example of FIG. 1, the system 85 is for instance communicatively connected with a camera 4, the camera 4 being applied as one of the measuring instruments. The field of view 5 of the camera is directed to a barn in which are a plurality of animals, among which animals 6-1 and 6-2. The animals 6-1 and 6-2 are both young bovines: on the one hand a calf 6-1 and on the other hand a yearling 6-2.

In the example of FIG. 1 the animals 6 themselves are also provided with a plurality of measuring instruments 13-17. This may be so in particular embodiments, but this is not necessarily so and usually even fewer measuring instruments are applied. In practice, only one of the measuring instruments 13-17 needs to be present to be able to gather sufficient data for carrying out a method according to the present invention. Thus, it may also be, for instance, that use is made of a neck tag 14 alone, or a neck tag 14 or ear tag 13 in combination with a camera 4. FIG. 1 shows only an overview of the different kinds of measuring instruments that may have been applied, on an animal 6 or internally in an animal 6. The measuring instruments 4 and 13-17 that are shown in FIG. 1 comprise inter alia: a camera 4, an ear tag 13, a neck tag 14, a tail tag 15, a stomach bolus 16, and a leg tag 17. Each tag may be provided with a plurality of sensors with which particular behavior and body parameters can be measured. Thus, for instance, each of the measuring instruments 13-17 may be provided with movement sensors for measuring movements that are made by the animal 6. Also, temperature sensors may be present in some of the measuring instruments 13-17 for measuring a body temperature, or by the measuring instruments, such as for example the ear tag 13 or the leg tag 17, a heart rate measurement may be performed.

From the data gathered with the sensors in each of the measuring instruments 13-17, body or behavior parameters may be determined and be sent as measuring values to the system 85. Thus, for instance, with movement sensors that are in the stomach bolus 16, movements may be measured that can be traced back to rumination activity of the animal 6 concerned. Rumination can also be established, for instance, with movements that are determined by the neck tag 14 or the ear tag 13. In another example, when the cow 6-2 brings down its head to eat the solid feed 12 from the feeding trough 11, such movement is observable with the movement sensors in, for instance, ear tag 13 or neck tag 14. Also, the stomach bolus 16 will be able to recognize stomach movements that are associated with the eating of the solid feed 12. With the tail tag 15, urinating or defecation by the cows 6 may be established, and possibly even an amount of excreted urine or dung. The calf 6-1, in the example of FIG. 1, is bottle-fed 10. This entails the calf raising its head upwards, which can also be established with the movement sensors in the tags 13 and 14. Of such activities, also parameters such as duration, intention and, for instance, an amount (of feed, dung, urine, milk) can be derived from the measuring values. In the present invention, the starting point has been bottle feeding 10, but also possible are alternative forms of milk consumption which are measurable in an adapted manner, such as milk consumption by bucket, weaning bucket, automatic drink dispenser, suckling the mother, milk bar, automatic milk dispenser, etc. Each form of milk consumption has associated specific movements that are measurable with for instance the movement sensors in tags 13 and 14.

According the present invention, for the purpose of determining a phase transition, with one or more measuring instruments 13-17 a few body or behavior parameters of the animals 6-1 and 6-2 are measured. The use may depend on the age category of the animal. For instance, when a very young animal is involved, such as a calf, the method according to the present invention may be used for detecting the phase transition of weaning. In weaning, a young animal makes a transition from bottle feeding or suckling its mother, to solid food 12. Initially, the solid food 12 will chiefly consist of concentrated feed (concentrate), but in the course of time the animal 6-2 will be eating roughage more and more. Not only with one of the measuring instruments 13-17 but also with the camera 4 (which also forms a measuring instrument here) can the behaviors of the animals 6-1 and 6-2 be recorded. As already indicated above, when the calf 6-1 gets bottled milk 10, it will keep its head in a particular position. This is detectable by the movement sensors in for instance the neck tag 14 or the ear tag 13. Even when the calf has just one of the measuring instruments 13-17 available (for example, the ear tag 13, the neck tag 14 or the stomach bolus 16), this movement can be established. But also when in a livestock farm no use is made of tags 13-17 attached to the animal, but, for instance, merely the camera 4 is used, it is possible to recognize the behaviors of the animals 6-1 and 6-2. With image recognition, it can be deduced that the calf 6-1 is getting bottle-fed. Also when the animal 6-2 eats from the feeding trough 11, this can be recognized, on the basis of image recognition, in the pictures of camera 4. In a livestock farm where exclusively a camera 4 is employed, there may for instance be several cameras present to be able to properly monitor all remote corners of the barn. Additionally, and also in the use of a camera 4, it is necessary that, either from the gathered video material or in any other way (for instance in an embodiment that does involve additional use of tags 13-17), the animals 6-1 and 6-2 be identified, for them to be registered in the livestock management system 85.

The livestock management system 85 may include a controller 91 and optionally an internal or external memory 88. As has already been noted above, the controller 91 does not necessarily need to be present in the livestock management system 85, as is the case in FIG. 1, but may also be only communicatively connected with system 85. The livestock management system 85 may further include the necessary algorithms in order for the body and behavior parameters determined with the measuring instruments 4, 13, 14, 15, 16 and 17 to be received and processed for detecting the phase transitions. Additionally or alternatively, the livestock management system 85 may possess, or be communicatively connected with, a self-learning data processing system which has been trained for the processing of phase transitions when the body or behavior parameters are presented to it as input.

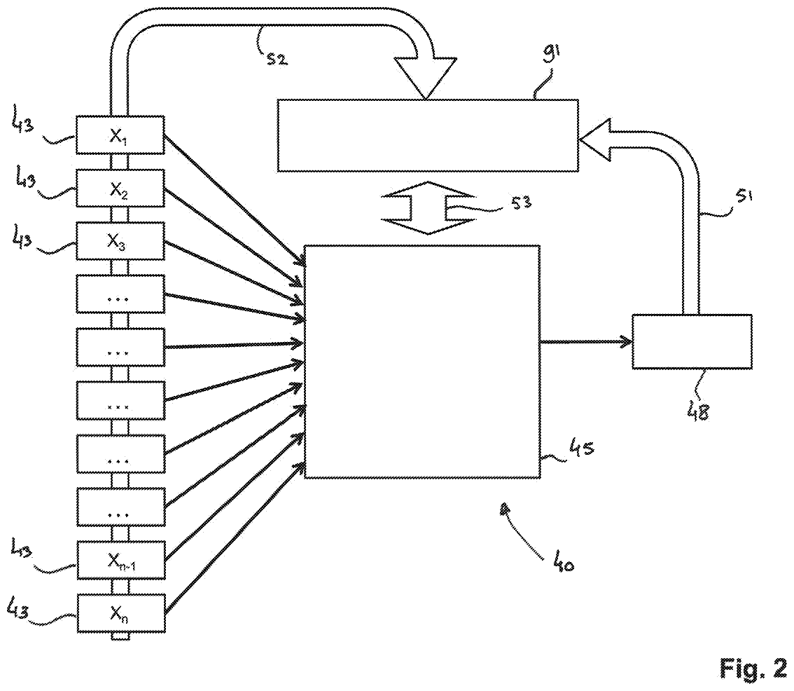

FIG. 2 shows schematically a training method for training a self-learning data processing model 40. The self-learning data processing model 40 comprises an input side 43 and an output side 48, and the core of the data processing model 40 is formed by decision model 45. Decision model may for instance be an arithmetic algorithm, such as an arithmetic regression model, but may also be formed by, for instance, a neural network or a random forest algorithm. Controller 91 is in charge of the training of the decision model 45.

According to the invention, the self-learning data processing model is trained in that, at the input 43, the desired body and/or behavior parameters that can have been obtained with the measuring instruments 4, 13-17 which are for instance shown in FIG. 1, are presented to the model 40. The decision model 45, for example a neural network, processes the input 43 and provides to the output 48 a hypothesis regarding the phase transition to be determined. In the training phase, the actual phase transition is established in a different manner, and presented to the controller 91 for verification. This may for instance be done in the conventional manner whereby the age of the animal 6-1 is looked at, or in a more accurate manner whereby the animal is daily examined to determine in what measure it absorbs solid feed already. This last may for instance be done by examining the excreted dung or urine for substances that are indicative of the absorption of solid feed 12. This verification step is merely needed in the training phase of the self-learning data processing model 40. Once the self-learning data processing model 40 has been trained, it can independently, on the basis of the input 43, give a phase transition hypothesis that accurately matches the actual phase transition. In other words, based on the input 43, the self-learning data processing model 40 can in that case predict whether the respective animal 6 undergoes a phase transition.

In the training phase, the output 48 is fed back via 51 to the controller 91. Via arrow 52, the controller 91 also receives all input values 43 which have been presented to the self-learning data processing model 40. These are the body and/or behavior parameters which have been measured with the measuring instruments 4, 13, 14, 15, 16 and/or 17. Because the controller 91, during the training phase, also has available the actual verification data regarding the occurrence of a phase transition in the respective animal 6-1, the controller 91 can adapt the decision model 45. This has been visualized in FIG. 2 using arrow 53. Adapting the decision model 40 may, for instance in the case of a neural network, involve adaptation of neurons. In a linear regression model, the coefficients of the regression model can be adapted, and in the case of a random forest algorithm the decision model 45 may be adapted by therein awarding some decision trees a greater weight than other decision trees, when they arrive at the right (or nearly the right) prediction. The training phase of the self-learning data processing model 40 may be ended when the self-learning data processing model 40 can reasonably reliably predict the occurrence of a phase transition. This may be checked in the same way on the ground of, for instance, observation of the animals, medical examination of the animals, or simply in the conventional way. In that case, the self-learning data processing model 40 can be used in a livestock management system 85 for carrying out a method according to the present invention.

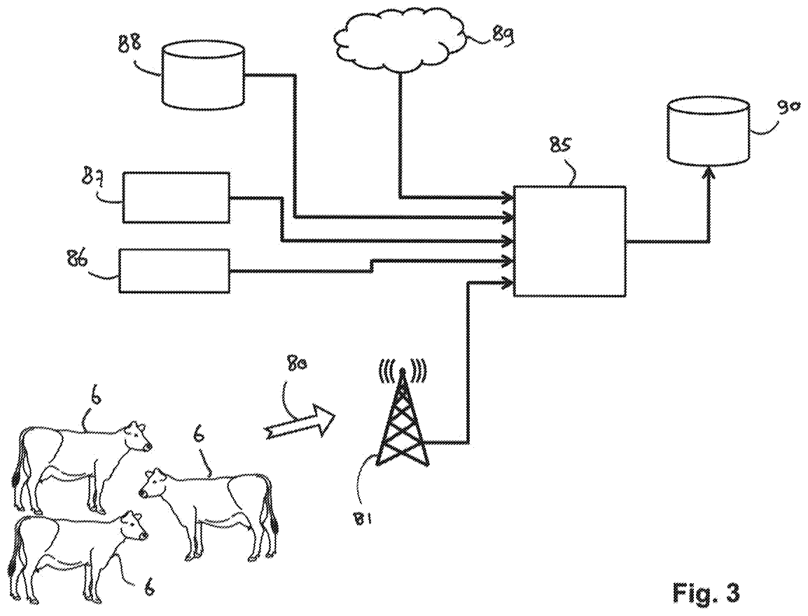

In FIG. 3, a livestock management system 85 according to the invention is shown in more detail. The livestock management system 85 is in communication with, for instance, a wireless data communication network comprising transceivers 81. With these, data signals can be exchanged within the farm, for instance with the tags 13-17 which are attached to the animals, or, for instance, the camera pictures of the camera 4. The skilled person will understand that the cameras 4 may also be connected with the livestock management system 85 through a direct wired connection. This makes no difference for the invention. The server 85 may also be connected with an external or internal memory 88 storing data regarding, for instance, the self-learning data processing model. Also, the server 85 may be connected with an external network 89 for downloading data. An internal memory 90 may be used for recording livestock management data of the animals 6. Other input sources may include for instance an ISO animal recognition system 86, or a positioning system 87 which monitors the positions of the animals 6. Such input sources are optional. Being able to identify the animals 6 is desirable for the livestock management system 85 to be able to establish and record for each of the animals 6 individually whether a phase transition has occurred.

The body or behavior parameters that may be gathered by any measuring instruments 13-17 are sent as measuring values 80 via the transceivers 81 to the server 85, and are presented as input to the self-learning data processing model 40, or to another arithmetic algorithm which processes the data. The established measuring values may for instance be compared with limiting values to enable establishing whether a phase transition has occurred. In a specific embodiment, it may for instance be deduced from the body or behavior parameters what the amount of solid food that has been eaten by each of the animals 6 is, and from this amount the extent of attention to solid food can be established for each of the animals 6 individually. This may be converted to a numerical value. The amount of solid food eaten by the animal 6 may be compared with a limiting value to establish whether a phase transition has taken place. Also, it is possible to compare different body or behavior parameters with limiting values to determine a phase transition on the basis of a combination of conditions. The server 85 thereupon determines the occurrence of a phase transition, and can record this in its internal memory 90, for instance in the livestock management records. Also, it is possible that livestock management system 85 generates an attention signal, which is for instance wirelessly transmitted to the farmer's cell phone or is brought to the farmer's attention in a different manner.

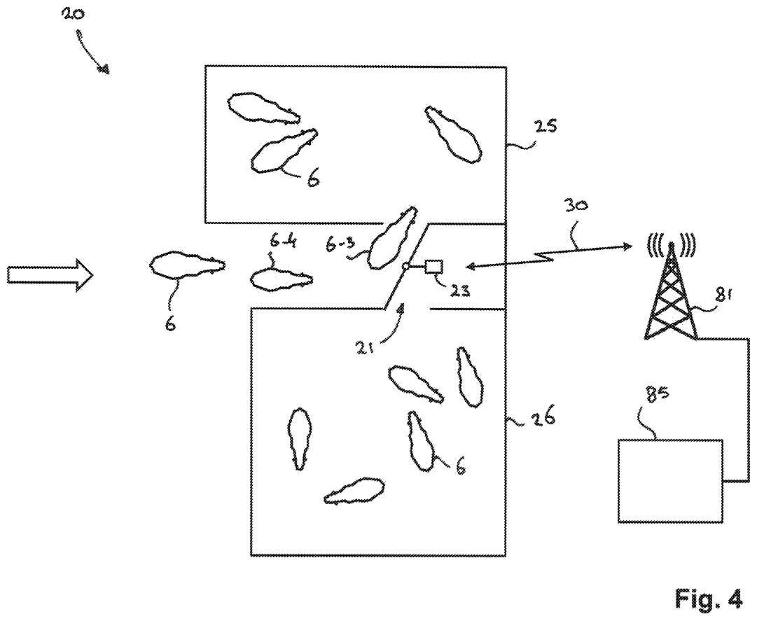

In yet another embodiment, shown in FIG. 4, a plurality of animals 6 are provided with measuring instruments, such as, for example, an ear tag 13. Each of the animals 6 can be identified on the basis of, for instance, the RFID signal of the tag 13. The livestock management system 85 may, via the transceivers 81, set up a data connection 30 with a separation gate 21. The separation gate 21 possesses a control element 23 which can set the position of the gate 21 on the basis of data received via the data connection 30. Further, the control element 23 may possess an ISO animal identification system, for example ISO animal identification system 86 shown in FIG. 3. When an animal 6 walks along the gate 21, the animal is individually recognized by the control element 23. The identity details of the recognized animal 6-3 are transmitted via the data connection to the server 85, and the server 85 will, in response, inform the control element 23 of the separation gate 21 about which of the pens 25 or 26 the animal 6-3 is to be guided into. Thus, animal 6-3 will be guided to the pen for older animals. When, for instance, calf 6-4 arrives at the separation gate 21, it will be identified by the control element 23, and in response to this the server 85 will inform the control element 23 that calf 6-4 is to be guided to pen 26 for calves. In this way, based on the detection of a phase transition, the animal 6 can be automatically placed in the right group. The skilled person will understand that the embodiment of FIG. 4 is optional, and that the invention may also be used without automatic detection and separation of animals. For in many cases, the farmer, while wishing to be advised about a transfer, will not necessarily wish this to be carried out automatically.

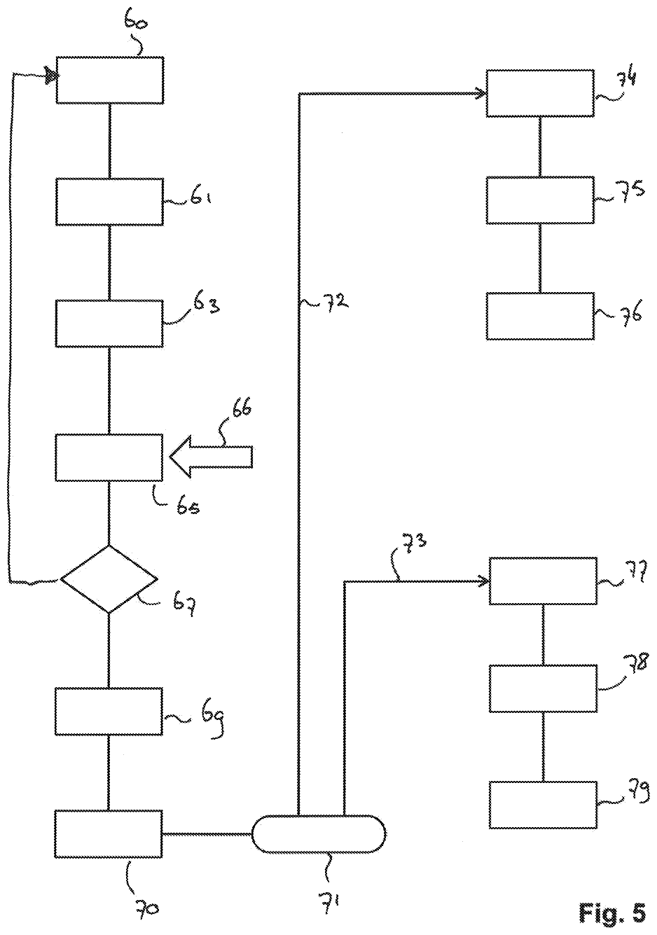

FIG. 5 shows schematically a method according to the present invention. In the method, step 60 concerns the measuring of body and/or behavior parameters using the measuring instruments 4, 13, 14, 15, 16 and/or 17. As has already been mentioned above, for this, several different measuring instruments per animal may be used, or just one single measuring instrument may be used. For instance, a single camera 4 can already gather data of a group of animals. The gathered measuring data are transmitted by each of the measuring instruments to a livestock management system 85. Step 61 concerns the receiving of the measured body and/or behavior parameters from the respective instruments. In step 63 the controller 91 of the livestock management system 85 will process the received data from step 61. In principle, instead of a central controller 91 in a livestock management system 85, also use can be made of local controllers in each of the measuring instruments. Thus, for instance, with a controller incorporated in a smart tag, a phase transition may already be established in the tag itself, and merely the result of the method will need to be sent to the livestock management system 85. In the following, it will be assumed that the controller 91 in the livestock management system 85 carries out these operations; however, the invention is not limited thereto.

In step 65 the processed measuring values are compared with a limiting value 66. For instance, a measured time duration of the time spent by an animal on milk consumption 10 may be compared with a limiting value 66, to establish whether the measured time duration falls below the limiting value 66. When the measured time duration is lower than the limiting value 66, this may be an indication that the animal pays more attention to solid food. Also, a combination of measuring values may be compared; for instance, the time duration spent on eating may be compared with a limiting value, while also the rumination time that the animal 6 spends on ruminating is measured and compared with the limiting value 66. For unweaned animals, which are still being raised entirely on milk consumption 10, it holds that neither eating time nor rumination time is measured, since the milk is not chewed, hence the animal spends no time doing so. However, when the animal slowly starts to eat solid feed, the eating time will increase (since the animal 6 now eats solid feed). In ruminants, also rumination time now starts to increase. The eating time and the rumination time may therefore both be compared with a limiting value again to establish whether the animal already eats solid feed and attention to it increases. When the animal 6 at some point is going to eat roughage alone, the eating time increases, and also the rumination time increases. By comparing this eating time and rumination time once again with limiting value 66, it can therefore be established in what measure the animal 6 is eating roughage already. On the basis thereof it can be reasonably accurately predicted whether a phase transition is taking place. In step 65, such comparisons with limiting values take place. Thereupon, in step 67, it is determined whether the data from step 65 show that a phase transition is taking place. When this is not so, the method proceeds with step 60 in which the body and behavior parameters are measured. If a phase transition is taking place, the method proceeds with step 69. In step 69, optionally an attention signal is produced by the livestock management system 85. The livestock management system 85 can draw the farmer's attention to the circumstance that a respective animal 6 is experiencing a phase transition, and that appropriate measures should therefore be taken. What these measures are, depends on the phase transition to be considered. Thus, the system may be used to see whether calves should be weaned, but it may also be used for migrating animals 6 to a new (older) group. The associated measures are slightly different in the two cases, as will be further explained in the following.

In step 70, the system, depending on the phase transition to be considered, can give advice regarding the measures to be taken. Thus, it is possible that the system 85 in step 70 has a run-down program for running down the amount of milk an animal 6-1 gets offered per day. In this way, weaning of the animal 6-1 can take place in a gradual manner. For instance in the case of migration to an older group, the system 85 can indicate a period of time within which such a migration should take place. In this manner, the system may for instance make a prediction of the different group sizes at different points in time.

The generic part of the method ends after step 70, as is indicated in terminal 71. The method can continue in different manners, depending on the phase transition to be detected. It is also possible that the system 85 implements the method to cause different phase transitions for different animals to be recorded. Thus, all young animals within the farmer's business can be monitored with the same system, keeping track, where the older animals are concerned, of when they are up for relocation to a different group and, where the younger animals are concerned, of when they should be weaned. Depending on the phase transition to be detected, the method continues via arrow 72 or arrow 73. When the phase transition concerns the weaning of animals, the method continues with step 74. In step 74 the system 85 provides, according to the method, advice with respect to the running down of the milk program for the respective animal. On the basis thereof, in step 75, the animal may for instance be transferred to a group of animals that are being weaned. Thereafter, optionally, in step 76, the animals concerned that are being weaned may be monitored with the aid of the measuring instruments 4 and 13-17.

When the phase transition concerns the relocation of the young animal 6 to an older age-group, in step 77 a period of time may be indicated within which the migration can take place optimally. In step 78, the relocation actually takes place, for example by automatic separation method, or so that the farmer himself puts the animal in the older group. Next, in step 79, a stress monitoring program is implemented, whereby the body or behavior parameters such as heart rate and/or unexpected movements are recorded to establish whether the animal 6 is suffering from stress. When the animal after transfer suffers from stress, it may be that the animal, despite the advice, is not yet ready for relocation, after all.

The above-described specific embodiments of the invention are intended for illustration of the principle of the invention. It is believed that the implementation and the operation of the invention are readily apparent from the foregoing description and the appended illustrations. The invention is not limited to any embodiment described or shown herein. For the sake of clarity and conciseness of the description, features have been described herein as part of the same or of separate embodiments; it will be clear to a person skilled in the art that embodiments comprising combinations of any or all of the features described also fall within the scope of protection of the invention. Within the ability of those skilled in the art, alterations are possible which are to be understood to be within the scope of protection. Also, all kinematic inversions are understood to be within the scope of protection of the present invention. Expressions such as “consisting of”, when used in this description or the appended claims, should be construed not as an exhaustive enumeration but rather in an inclusive sense of “at least consisting of”. Indications such as “a” or “one” may not be construed as a limitation to just a single specimen, but have the meaning of “at least a single specimen” and do not preclude plurality. Expressions such as: “means for . . . ” should be read as: “component configured for . . . ” or “member constructed to . . . ” and should be construed to cover all equivalents of the structures described. The use of expressions such as: “critical”, “advantageous”, “preferably”, “desired”, et cetera, is not intended to limit the invention. Moreover, also features that are not specifically or expressly described or claimed in the construction according to the invention but do lie within reach of the skilled person, are understood to be encompassed without departing from the scope of protection as defined by the appended claims.

1. A method for determining in a young animal a phase transition from a first development phase to a second development phase, the method comprising:
measuring, using a measuring instrument during a period of time, one or more body or behavior parameters of the young animal and producing one or more measuring values for each body or behavior parameter;
receiving, by a controller, the one or more measuring values and detecting the phase transition on the basis of the measuring values;
wherein the detecting the phase transition comprises processing, by the controller, each of the measuring values and, depending thereon, determining an extent of attention, by the young animal, to solid food, for on the basis thereof detecting the phase transition.

2. The method according to claim 1, wherein the detecting the phase transition comprises:
comparing, by the controller, at least one measuring value with a limiting value, and
establishing the phase transition when the at least one measuring value has exceeded or fallen below the limiting value.

3. The method according to claim 2, wherein the one or more body or behavior parameters comprise at least element taken from the group consisting of: eating time, amount of consumed solid food, amount of milk drunk, rumination amount, number of rumination boluses and number of rumination strokes, time spent on drinking milk, ratio between eating time and rumination time, amount of absorbed food with respect to absorbed amount of solid food, weight, development, height, width, activity, shape, rumen filling, hygiene score, locomotion score, water drinking, time spent in different fields of interest.

4. The method according to claim 1, wherein the controller is configured for implementing a data processing model, wherein the detecting the phase transition comprises inputting, using the controller, at least one of the measuring values in the data processing model and determining with the data processing model whether an amount of solid food that has been consumed by the animal has exceeded a threshold value.

5. The method according to claim 4, wherein the data processing model is a self-learning data processing model, wherein the self-learning data processing model has been trained in a training method through input of a training set including training measuring values of at least one of the one or more body or behavior parameters and result values associated with the training measuring values, the result values comprising at least one of the group consisting of:
a Boolean value indicating whether the amount of solid food that has been consumed by the animal has exceeded a threshold value; and
an expectation value of the amount of solid food that has been consumed by the animal.

6. The method according to claim 5, wherein the self-learning data processing model is at least one from a group consisting of: a neural network, a random forest algorithm, and an arithmetic regression model.

7. The method according to claim 4, wherein the one or more body or behavior parameters comprise at least one element from a group consisting of: eating time, rumination amount, number of rumination boluses and number of rumination strokes, heart rate, heart rate variation, oxygen saturation level, and breathing frequency.

8. The method according to claim 1, wherein the first development phase is a suckling phase and the second development phase is a weaning phase.

9. The method according to claim 8, wherein the method further comprises providing, depending on the determined extent of the animal's attention to solid food, an indication signal for running down the suckling phase.

10. The method according to claim 8, wherein the method comprises determining, depending on the determined extent of the animal's attention to solid food, an advised value of an amount of milk per period of time that can be offered to the animal.

11. The method according to claim 4, wherein a phase transition criterion comprises at least one of the group consisting of:
the phase transition is established when the amount of solid food that has been consumed by the animal is at least 0.1 kilogram per day;
the animal is a calf and the phase transition is established when the amount of solid food that has been consumed by the animal is at least 0.5 kilogram per day;
the animal is a piglet and the phase transition is established when the amount of solid food that has been consumed by the animal is at least 50 grams per day; and
the phase transition is established when the amount of solid food that has been consumed by the animal is at least 0.5% of a body weight of the animal per day.

12. The method according to claim 1, wherein the phase transition is accompanied by a displacement of the animal from a group of animals in a first age category to a group of animals in a second age category, and wherein the method further comprises:
monitoring, after displacement of the animal, at least one of the one or more body or behavior parameters, and
determining therefrom a state of health of the animal.

13. The method according to claim 1, further comprising producing an attention signal when the amount of solid food that has been consumed by the animal has exceeded a threshold value.

14. The method according to claim 1, wherein the measuring instrument is at least one instrument taken from the group consisting of: an ear tag, a neck tag, a leg tag, a stomach bolus, a tail sensor, a camera, and a microphone.

15. The method according to claim 1, wherein the sensors comprise at least one sensor taken from the group consisting of: a movement sensor, a heart rate sensor, a breathing sensor, an optical sensor for measuring one or more blood levels, a positioning system for determining a current position, a pressure sensor, and a chromatograph.

16. The method according to claim 1, wherein the animal is a ruminant and the one or more body or behavior parameters comprise at least the number of rumination boluses,
wherein the measuring instrument is designed with a movement sensor, and
wherein the number of rumination boluses is measured by at least one of the measuring methods taken from the group consisting of:
with the movement sensor, measuring animal movements, analyzing the measured animal movements for distinguishing movements that are indicative of rumination strokes, recognizing a rumination stroke pattern consisting of one or more series of rumination strokes which are each followed by a pause in which no rumination strokes are observed, and counting at least one of the number of series of rumination strokes or the number of pauses for establishing the number of rumination boluses, wherein each series or each pause represents one rumination bolus; and
with the movement sensor, measuring animal movements, analyzing the measured animal movements for distinguishing movements that are indicative of at least one of regurgitations or swallowing movements, and counting the number of regurgitations or swallowing movements for establishing the number of rumination boluses.

17. The method according to claim 1, wherein measurements are obtained by at least one method taken from the group consisting of:
the measuring instrument is physically or communicatively connected with the controller;
the measuring instrument and the controller are part of a same device attached to or introduced into the animal; and
the controller is contained in a livestock management server, wherein the measuring instrument sends the measuring values via a wireless connection to the controller.

18. The method according to claim 1, wherein measurements are obtained by at least one method taken from the group consisting of:
the measuring instrument is attached to or introduced into the animal and is provided with one or more sensors; and
the measuring instrument is a camera which is operatively connected with an image recognition system for establishing the body or behavior parameters.

19. The method for training a self-learning data processing model for use in a method according to claim 1, wherein the self-learning comprises:
inputting into the data processing model a training set consisting of training measuring values,
wherein the training measuring values comprise one or more body or behavior parameters and result values,
wherein the result values are associated with the training measuring values, and
wherein the result values comprise at least one element of the group consisting of:
a Boolean value indicating whether the amount of solid food that has been consumed by the animal has exceeded a threshold value; and
an expectation value of an amount of solid food that has been consumed by the animal.

20. A stock management system configured for carrying out a method for, individually in each animal of a group of young animals, determining a phase transition from a first development phase to a second development phase, the system comprising:
a plurality of measuring instruments attachable to or introducible into an animal of the group of animals, wherein the measuring instruments are each provided with one or more sensors for measuring during a period of time one or more body or behavior parameters of the respective animal, and producing one or more measuring values for each measured body or behavior parameter; and
a controller configured for receiving the one or more measuring values from each measuring instrument and detecting the phase transition on the basis of the measuring values; wherein the detecting the phase transition comprises processing, by the controller, each measuring value and, depending thereon, determining whether an amount of solid food that has been consumed by the animal has exceeded a threshold value.
